(19) United States
(12) Patent Application Publication
(10) Pub. No.: US 2024/0380138 A1
(43) Pub. Date: Nov. 14, 2024

(54) BATTERY TERMINAL COVER AND BATTERY TERMINAL UNIT

(71) Applicant: Yazaki Corporation, Tokyo (JP)

(72) Inventors: Norimasa YABASE, Hiroshima (JP); Nhat Hieu VU, Hiroshima (JP)

(73) Assignee: Yazaki Corporation, Tokyo (JP)

(21) Appl. No.: 18/655,915

(22) Filed: May 6, 2024

(30) Foreign Application Priority Data
May 8, 2023 (JP) 2023-076474

(51) Int. Cl. H01R 11/28

(52) U.S. Cl. CPC H01R 11/287; H01R 11/284; H01R 2201/26

(57) ABSTRACT

A battery terminal cover includes a cover portion and a rotation stop portion. The rotation stop portion has a contact surface formed by chamfering. The contact surface is formed at a position out of a moving region of a mating connector with respect to a connector provided on the battery terminal. The contact surface contacts a corner part of a battery wall to regulate rotation of the battery terminal in a direction toward the battery wall. The contact surface is formed to absorb a dimensional tolerance between the battery post and a wall surface of the battery wall and a dimensional tolerance between the battery post and a side surface of the battery wall. The wall surface and the side surface forms the corner part.

### CROSS-REFERENCE TO RELATED APPLICATIONS

The present application is based on, and claims priority from the prior Japanese Patent Application No. 2023-076474, filed on May 8, 2023, the entire contents of which are incorporated herein by reference.

### TECHNICAL FIELD

The disclosure relates to a battery terminal cover and a battery terminal unit.

### BACKGROUND

There has been known a member that regulates rotation of a battery terminal when the battery terminal is assembled to a battery post installed in a standing manner on an upper surface of a battery housing.

Patent Literature 1 (JP 2015-118855 A) discloses a battery terminal provided with a stopper as a member that regulates rotation of the battery terminal. The stopper has a first rotation stop portion and a second rotation stop portion.

In a state where the battery terminal is assembled to the battery post, the first rotation stop portion contacts a side surface of the battery housing, and the second rotation stop portion contacts a wall surface of a battery wall which is provided on an upper surface of the battery housing and is orthogonal to the side surface of the battery housing.

This configuration allows the rotation of the battery terminal to be regulated, with the battery post as a rotation center.

### SUMMARY OF THE INVENTION

In Patent Literature 1, the first rotation stop portion contacts the side surface of the battery housing, which regulates the rotation of the battery terminal in a direction toward the battery housing (counterclockwise direction) with the battery post as the rotation center.

However, there is a manufacturing error (dimensional tolerance) between the battery post and the side surface of the battery housing. Therefore, when a distance between the battery post and the side surface of the battery housing becomes shorter than a reference value within the dimensional tolerance, the first rotation stop portion rotates in the counterclockwise direction extra to contact the side surface of the battery housing due to the shorter distance.

In this case, since a space where a battery is arranged is small, there is a possibility that a member connected to the battery terminal, such as an electric wire, interferes with peripheral components. In this case, for example, the interference affects a coating of the electric wire such that the coating is damaged due to vibration of a vehicle.

Therefore, further improvements are needed to able to stop the battery terminal in a proper position while absorbing a tolerance in the battery.

The disclosure is made in view of the problems of such a conventional technique. An object of the disclosure is to provide a battery terminal cover and a battery terminal unit that can stop a battery terminal in a proper position while absorbing a tolerance in a battery when assembling the battery terminal to a battery post.

According to a first aspect of the embodiment, there is provided a battery terminal cover including a cover portion to be attached to a battery terminal, and a rotation stop portion that is extended from the cover portion, and has a contact surface formed by chamfering. In a state where the cover portion is attached to the battery terminal, when the battery terminal is assembled to a battery post standing on an upper surface of a battery housing, the contact surface contacts a corner part of a battery wall provided on the upper surface of the battery housing. The contact surface is formed at a position out of a moving region of a mating connector with respect to a connector provided on a side of one end of the battery terminal. The contact surface is formed to absorb a dimensional tolerance between the battery post and a first surface of the battery wall and a dimensional tolerance between the battery post and a second surface of the battery wall, the first surface and the second surface forming the corner part. The contact surface contacts the corner part to regulate rotation of the battery terminal in a direction toward the battery wall with the battery post as a rotation center.

According to a second aspect of the embodiment, there is provided a battery terminal unit including a battery terminal to be assembled to a battery post standing on an upper surface of a battery housing, and a battery terminal cover. The battery terminal cover includes a cover portion to be attached to the battery terminal, and a rotation stop portion that is extended from the cover portion, and has a contact surface formed by chamfering. In a state where the cover portion is attached to the battery terminal, when the battery terminal is assembled to the battery post, the contact surface contacts a corner part of a battery wall provided on the upper surface of the battery housing. The contact surface is formed at a position out of a moving region of a mating connector with respect to a connector provided on a side of one end of the battery terminal. The contact surface is formed to absorb a dimensional tolerance between the battery post and a first surface of the battery wall and a dimensional tolerance between the battery post and a second surface of the battery wall, the first surface and the second surface forming the corner part. The contact surface contacts the corner part to regulate rotation of the battery terminal in a direction toward the battery wall with the battery post as a rotation center.

According to the disclosure, it is possible to provide a battery terminal cover and a battery terminal unit that can stop a battery terminal in a proper position while absorbing a tolerance in a battery when assembling the battery terminal to a battery post.

### BRIEF DESCRIPTION OF DRAWINGS

FIG. 1 is a partial perspective view illustrating one example of a state where a battery terminal unit according to the present embodiment is mounted to a battery.

FIG. 2 is a diagram viewed from an arrow II in FIG. 1.

FIG. 3 is a plan view of the battery terminal unit according to the present embodiment.

FIG. 4 is an explanatory diagram illustrating tolerances in the battery.

FIG. 5A is an explanatory diagram illustrating absorption of the tolerances by the battery terminal cover according to the present embodiment.

FIG. 5B is an explanatory diagram illustrating absorption of the tolerances by the battery terminal cover according to the present embodiment.

FIG. 5C is an explanatory diagram illustrating absorption of the tolerances by the battery terminal cover according to the present embodiment.

FIG. 6 is a plan view of the battery terminal unit according to a modified example of the present embodiment.

FIG. 7A is an explanatory diagram illustrating absorption of the tolerances by the battery terminal cover according to the modified example of the present embodiment.

FIG. 7B is an explanatory diagram illustrating absorption of the tolerances by the battery terminal cover according to the modified example of the present embodiment.

FIG. 7C is an explanatory diagram illustrating absorption of the tolerances by the battery terminal cover according to the modified example of the present embodiment.

### DETAILED DESCRIPTION OF THE INVENTION

A battery terminal unit and a battery terminal cover according to the present embodiment will be described below with reference to the accompanying drawings in detail. Note that the dimensional proportions in the drawings are exaggerated for the sake of explanation and may differ from the actual proportions. The same functions or structures will be denoted by the same or similar reference numerals, and their descriptions will be omitted as appropriate.

### (Configuration of Battery)

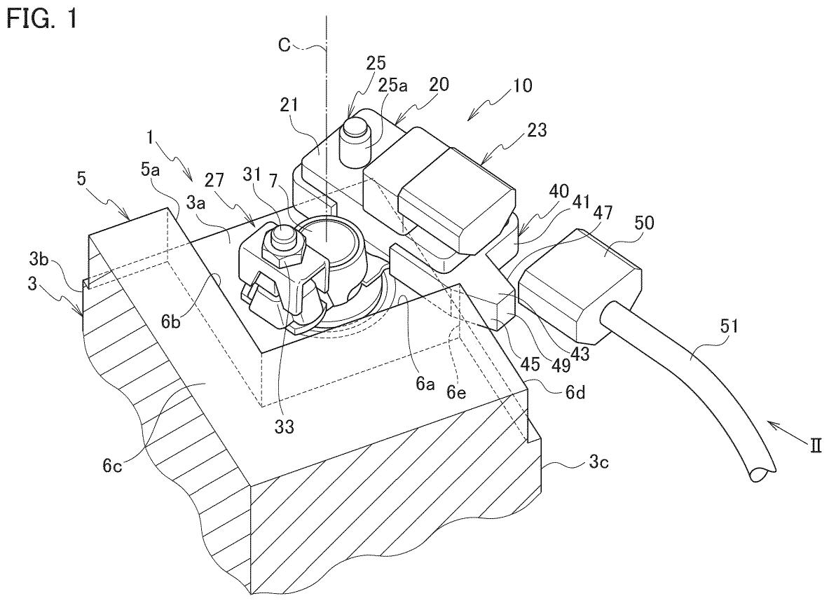

First, a configuration of a battery 1 will be described with reference to FIG. 1. FIG. 1 is a partial perspective view illustrating one example of a state where a battery terminal unit 10 is mounted to the battery 1.

As illustrated in FIG. 1, the battery 1 is an electric storage device installed in a vehicle, and includes a battery housing 3, a battery wall 5, and a battery post 7. The battery housing 3 accommodates component parts of the battery 1. The battery housing 3 has an upper surface 3a, a front surface 3b, and a side surface 3c. The upper surface 3a is formed on an upper side of the battery housing 3 in a vertical direction. The front surface 3b and the side surface 3c are orthogonal to the upper surface 3a, and are included in a peripheral surface of the battery housing 3. The battery wall 5 is provided on the upper surface 3a of the battery housing 3.

The battery wall 5 has a cutout portion 5a in a corner of the battery 1, which is cut out in a substantially L-letter shape in a plane view of the battery housing 3. Therefore, the upper surface 3a of the battery housing 3 is exposed at the corner of the battery 1. The number of corners of the battery 1 each of which has the cutout portion 5a is at least one.

The battery wall 5 has wall surfaces 6a, 6b, an upper surface 6c, and a side surface 6d. The wall surfaces 6a, 6b are exposed in the cutout portion 5a of the battery wall 5. The wall surface 6a is orthogonal to a plane parallel to the side surface 3c of battery housing 3. The wall surface 6b is connected to the wall surface 6a, and is parallel to the side surface 3c of the battery housing 3. The upper surface 6c is formed on an upper side of the battery wall 5 in the vertical direction. The side surface 6d is connected to the wall surface 6a, and is parallel to the side surface 3c of the battery housing 3.

The wall surface 6a and the side surface 6d of the battery wall 5 form a corner part 6e of the battery wall 5. As described below, the battery terminal unit 10 contacts the corner part 6e of the battery wall 5 when the battery terminal unit 10 is mounted to the battery 1. In this case, the battery terminal unit 10 contacts the corner part 6e of the battery wall 5 from a side of the side surface 3c of the battery housing 3. Note that the wall surface 6a and the side surface 6d forming the corner part 6e are also referred to as the first surface and second surface, respectively.

The battery post 7 is formed in a substantially cylindrical shape, and stands on the upper surface 3a of the battery housing 3 which is exposed at the corner of the battery 1. A center axis C of the battery post 7 is orthogonal to the upper surface 3a of the battery housing 3.

### (Configuration of Battery Terminal Unit)

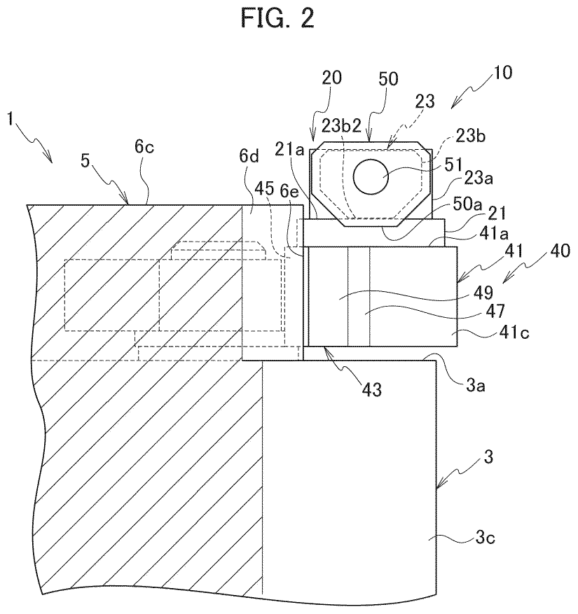

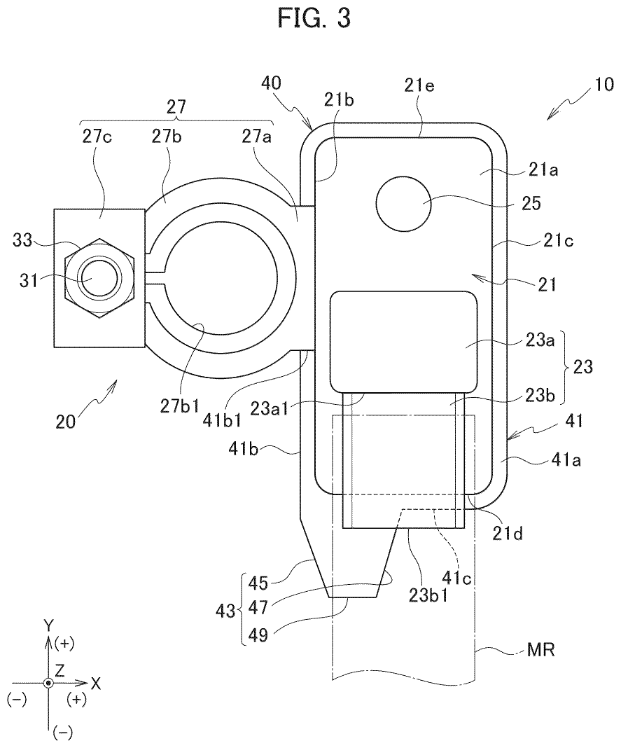

Next, a configuration of the battery terminal unit 10 will be described with reference to FIG. 1 to FIG. 3. FIG. 2 is a diagram viewed from an arrow II in FIG. 1. FIG. 3 is a plan view of the battery terminal unit 10.

As illustrated in FIG. 1 to FIG. 3, the battery terminal unit 10 is a component part that is mounted to the battery 1, and includes a battery terminal 20 and a battery terminal cover 40. The battery terminal 20 is a part to be assembled to the battery post 7 and used to electrically connect the battery 1 to a member connected to the battery terminal 20.

The battery terminal 20 has a main body portion 21, a connector 23, a stud bolt 25, and a tightening portion 27. The main body portion 21 is provided with the connector 23, the stud bolt 25, and the tightening portion 27. The main body portion 21 is formed in a substantially rectangular parallelepiped shape, and has an upper surface 21a and side surfaces 21b to 21e (see FIG. 3). The shape of the main body portion 21 is not limited to the substantially rectangular parallelepiped shape.

An X-direction shown in FIG. 3 corresponds to a short side direction of the main body portion 21. A Y-direction shown in FIG. 3 corresponds to a long side direction of the main body portion 21, and is orthogonal to the X direction. A Z-direction shown in FIG. 3 corresponds to a height direction of the main body portion 21, and is orthogonal to the X direction and the Y direction.

The upper surface 21a is formed on the upper side of the main body portion 21 in the vertical direction (Z-direction). The side surfaces 21b to 21e are orthogonal to the upper surface 21a, and constitute a periphery surface of the main body portion 21. The side surface 21b is a side surface on a long side of the main body portion 21, and is formed on a side of one end (−X side) of a short side of the main body portion 21. The side surface 21c is a side surface on the long side of the main body portion 21, and is formed on a side of the other end (+X side) of the short side of the main body portion 21.

The side surface 21d is a side surface on the short side of the main body portion 21, and is formed on a side of one end (−Y side) of the long side of the main body portion 21. The side surface 21c is a side surface on the short side of the main body portion 21, and is formed on a side of the other end (+Y side) of the long side of the main body portion 21.

The connector 23 has a connector main body portion 23a and a connector fitting portion 23b. The connector main body portion 23a is provided near a center of the upper surface 21a of the main body portion 21 in the long side direction (Y-direction) of the main body portion 21. Note that the location where the connector body part 23a is provided is not limited to near the center of the upper surface 21a, but may be on a side of the side surface 21d (−Y side) of the upper surface 21a.

The connector fitting portion 23b is provided at one end 23al (−Y side) of the connector main body portion 23a, and is fitted with a mating connector 50. The mating connector 50 is provided to an end of a cable 51 connected to a device in the vehicle in which the battery 1 is mounted (see FIG. 1).

A moving region MR illustrated in FIG. 3 indicates a region where the mating connector 50 moves when the mating connector 50 is fitted to the connector fitting portion 23b. As illustrated in the moving region MR, the mating connector 50 moves along the long side direction (Y-direction) of the main body portion 21, and is fitted to the connector fitting portion 23b of the connector 23 from the side of the side surface 21d of the main body portion 21. When the mating connector 50 is fitted to the connector fitting portion 23b, the mating connector 50 is electrically connected to the battery 1 via the connector 23. The moving region MR is also referred to as a cable connecting track.

As illustrated in FIG. 1 and FIG. 3, in the long side direction of the main body portion 21, an end 23b1 of the connector fitting portion 23b is located on the −Y side of the main body portion 21 beyond the side surface 21d of the main body portion 21. As a result of this configuration, the end 23b1 of the connector fitting portion 23b protrudes toward the −Y side beyond the main body portion 21.

In a state where the battery terminal 20 is assembled to the battery post 7, the upper surface 6c of the battery wall 5 is located above a lower end 23b2 of the connector 23 in the height direction (Z-direction) of the main body portion 21 (see FIG. 2). Also, in a state where the mating connector 50 is fitted to the connector fitting portion 23b, the upper surface 6c of the battery wall 5 is located above a lower end 50a of the mating connector 50 in the height direction (Z-direction) of the main body portion 21 (see FIG. 2).

The stud bolt 25 is provided on a side of the side surface 21e (+Y side) of the main body portion 21, and has a shaft portion 25a protruding from the upper surface 21a of the main body portion 21. A mating terminal provided to an end of a cable can be connected to the shaft portion 25a. When the mating terminal is connected to the shaft portion 25a, the mating terminal is electrically connected to the battery 1 via the stud bolt 25.

The tightening portion 27 is provided on a side of the side surface 21b of the main body portion 21, and has an extending part 27a, an insertion part 27b, and a tightening part 27c. The extending part 27a extends from the side surface 21b of the main body portion 21 in a direction away from the main body portion 21. An extending direction of the extending portion 27a is parallel to the short side direction (X-direction) of the main body portion 21.

The insertion part 27b is connected to the extending part 27a. The insertion part 27b is formed in a substantially annular shape, and has a post insertion hole 27b1. When the battery terminal 20 is assembled to the battery post 7, the battery post 7 is inserted into the post insertion hole 27b1.

The tightening part 27c is connected to the insertion part 27b, and has a bolt 31 and a nut 33. The tightening part 27c tightens an end of the insertion part 27b with the bolt 31 and the nut 33 in a state where the battery post 7 is inserted in the post insertion hole 27b1. When the tightening part 27c tightens the end of the insertion part 27b, a diameter of the post insertion hole 27b1 is reduced and the battery post 7 is secured in the post insertion hole 27b1. Thus, the battery terminal 20 is assembled to the battery post 7 by tightening force of the tightening part 27c.

The battery terminal cover 40 is attached to the battery terminal 20 so as to surround an outer circumference surface of the main body portion 21 of the battery terminal 20. For example, the battery terminal cover 40 is attached to the battery terminal 20 by engaging an engaging portion (not illustrated) provided on an inner circumference surface of the battery terminal cover 40 with an engaged portion (not illustrated) provided on the outer circumference surface of the main body portion 21 of the battery terminal 20.

The battery terminal cover 40 is a member used to regulate rotation of the battery terminal 20 with the battery post 7 as a rotation center, when the battery terminal 20 is assembled to the battery post 7. The battery terminal cover 40 is also a member that protects the battery terminal 20.

The battery terminal cover 40 is made of a resin material or the like, and has a cover portion 41 and a rotation stop portion 43. The cover portion 41 is formed in a rectangular frame shape along the outer circumference surface of the main body portion 21 of the battery terminal 20. In a state where the battery terminal cover 40 is attached to the battery terminal 20, a short side direction, a long side direction, and a height direction of the cover portion 41 correspond to the short side direction, the long side direction, and the height direction of the main body portion 21 of the battery terminal 20, respectively.

The cover portion 41 has an upper surface 41a and side surfaces 41b, 41c. The upper surface 41a is formed on an upper side of the cover portion 41 in the vertical direction. The side surfaces 41b, 41c are orthogonal to the upper surface 41a, and are included in a peripheral surface of the cover portion 41. The side surface 41b is a side surface on a long side of the cover portion 41, and is formed on a side of one end of the short side of the cover portion 41. The side surface 41c is a side surface on a short side of the cover portion 41, and is formed on a side of one end of the long side of the cover portion 41.

In a state where the battery terminal cover 40 is attached to the battery terminal 20, the upper surface 41a of the cover portion 41 is located below the upper surface 21a of the main body portion 21 and below the lower end 23b2 of the connector fitting portion 23b of the connector 23, in the height direction (Z-direction) of the main body portion 21 of the battery terminal 20 (see FIG. 2). Further, in a state where the battery terminal 20 is assembled to the battery post 7, the upper surface 41a of the cover portion 41 is located below the upper surface 6c of the battery wall 5 in the height direction (Z-direction) of the main body portion 21 of the battery terminal 20 (see FIG. 2). Furthermore, in a state where with the mating connector 50 is fitted to the connector fitting portion 23b, the upper surface 41a of the cover portion 41 is located below the lower end 50a of the mating connector 50 in the height direction (Z-direction) of the main body portion 21 of the battery terminal 20 (see FIG. 2).

A penetrating portion 41b1 is formed on the side surface 41b. In a state where the battery terminal cover 40 is attached to the battery terminal 20, the extending part 27a of the tightening portion 27 of the battery terminal 20 extends from the side surface 21b of the main body portion 21 in a direction away from the main body portion 21 through the penetrating portion 41b1 of the cover portion 41.

The rotation stop portion 43 is extended from the side surface 41c of the cover portion 41 such that the rotation stop portion 43 protrudes in a direction away from the cover portion 41. An extension direction of the rotation stop portion 43 is parallel to the long side direction of the cover portion 41. A height of the rotation stop portion 43 is the same as a height of the side surface 41c of the cover portion 41 (see FIG. 2).

The rotation stop portion 43 has a contact surface 45, an inclined surface 47, and a tip surface 49. The contact surface 45 is a flat surface formed by chamfering from one of tip corners of the rotation stop portion 43, and is connected to the side surface 41b of the cover portion 41. The inclined surface 47 is a flat surface formed by chamfering the other of tip corners of the rotation stop portion 43, and is connected to the side surface 41c of the cover portion 41. The tip surface 49 is parallel to the side surface 41c of the cover portion 41, and is connected to the contact surface 45 and the inclined surface 47.

As illustrated in FIG. 3, the contact surface 45 is formed at a position out of the moving region MR of the mating connector 50 with respect to the connector 23. As described below, when the battery terminal 20 is assembled to the battery post 7, the contact surface 45 contacts the corner part 6e of the battery wall 5 to regulate the rotation of the battery terminal 20 in a direction toward the battery wall 5 with the battery post 7 as the rotation center.

Note that a side of the side surface 41b of the cover portion 41 on the contact surface 45 is also referred to as a root side of the rotation stop portion 43. A side of the tip surface 49 on the contact surface 45 is also referred to as a tip side of the rotation stop portion 43.

### (Tolerances in Battery)

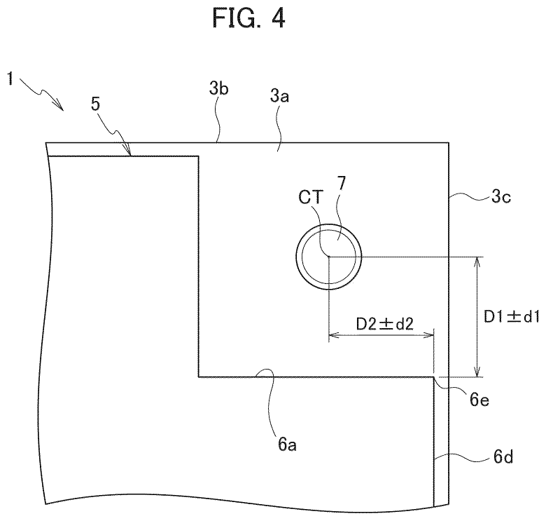

Next, tolerances in the battery 1 will be described with reference to FIG. 4. FIG. 4 is an explanatory diagram illustrating tolerances in the battery 1. In this embodiment, the tolerances in the battery 1 includes a tolerance between the battery post 7 and the wall surface 6a of the battery wall 5 and a tolerance between the battery post 7 and the side surface 6d of the battery wall 5. The wall surface 6a and the side surface 6d forms the corner part 6e of the battery wall 5.

In this embodiment, for a distance between a center CT of the battery post 7 and the wall surface 6a of the battery wall 5 in a plan view of the battery 1, a dimensional tolerance of −d1 to +d1 is allowed with respect to a reference value D1, as illustrated in FIG. 4. Therefore, the distance between the center CT of the battery post 7 and the wall surface 6a of the battery wall 5 has a value within a range of D1−d1 to D1+d1. Note that the dimensional tolerance of −d1 to +d1 with respect to the reference value D1 is also referred to as a first dimensional tolerance. The distance between the center CT of the battery post 7 and the wall surface 6a of the battery wall 5 is also referred to as a first distance.

Similarly, in this embodiment, for a distance between the center CT of the battery post 7 and the side surface 6d of the battery wall 5 in a plan view of the battery 1, a dimensional tolerance of −d2 to +d2 is allowed with respect to a reference value D2. Therefore, the distance between the center CT of the battery post 7 and the side surface 6d of the battery wall 5 has a value within a range of D2−d2 to D2+d2. Note that the dimensional tolerance of −d2 to +d2 with respect to the reference value D2 is also referred to as a second dimensional tolerance. The distance between the center CT of the battery post 7 and the side surface 6d of the battery wall 5 is also referred to as a second distance.

The tolerance between the battery post 7 and the side surface 6d of the battery wall 5 may be determined based on a tolerance between the battery post 7 and the side surface 3c of the battery housing 3, and a tolerance between the side surface 6d of the battery wall 5 and the side surface 3c of the battery housing 3.

### (Absorption of Tolerances by Battery Terminal Cover)

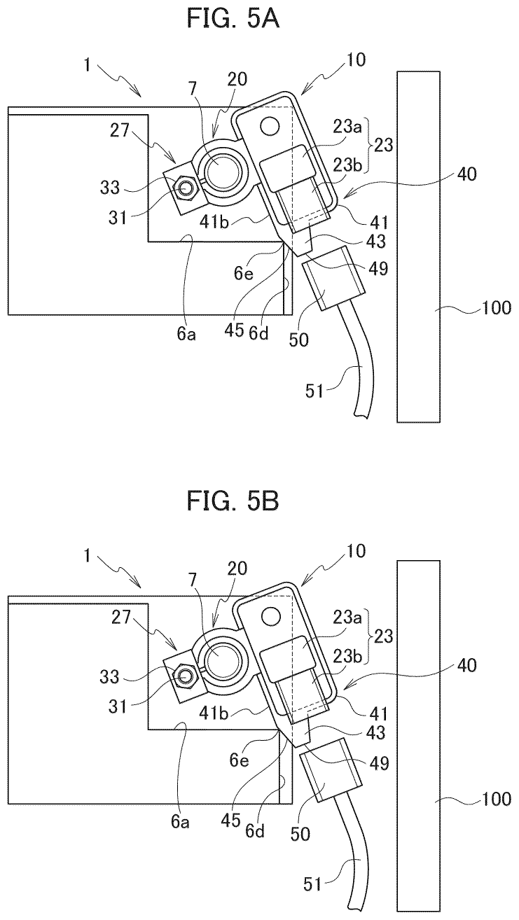

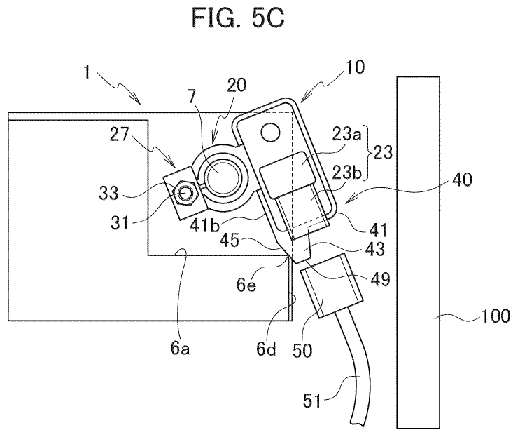

Next, absorption of the tolerances by the battery terminal cover 40 will be described with reference to FIGS. 5A to 5C. FIG. 5A is an explanatory diagram illustrating absorption of the tolerances by the battery terminal cover 40 when the first distance and the second distance have the reference values, respectively. FIG. 5B is an explanatory diagram illustrating absorption of the tolerances by the battery terminal cover 40 when the first distance and the second distance have minimum values within the first dimensional tolerance and the second dimensional tolerance, respectively. FIG. 5C is an explanatory diagram illustrating absorption of the tolerances by the battery terminal cover 40 when the first distance and the second distance have maximum values within the first dimensional tolerance and the second dimensional tolerance, respectively.

First, rotation of the battery terminal unit 10 will be described. The battery terminal unit 10 is formed by attaching the battery terminal cover 40 to the battery terminal 20.

In order to assemble the battery terminal 20 to the battery post 7, in a state where the battery terminal unit 10 is formed, the battery post 7 of the battery 1 is inserted into the post insertion hole 27b1 of the insertion part 27b in the tightening portion 27 of the battery terminal 20. After the battery post 7 is inserted into the post insertion hole 27b1, the nut 33 of the tightening part 27c in the tightening portion 27 of the battery terminal 20 is rotated in a clockwise direction to tighten an end of the insertion part 27b.

At this time, the battery terminal unit 10 rotates in a clockwise direction around the central axis C of the battery post 7 as the nut 33 is rotated. The battery terminal unit 10 rotates until the contact surface 45 of the rotation stop portion 43 of the battery terminal cover 40 contacts the corner part 6e of the battery wall 5 (see FIGS. 5A to 5C).

When the contact surface 45 contacts the corner part 6e of the battery wall 5, the rotation of the battery terminal unit 10 is stopped. In this state, the battery post 7 is secured to the post insertion hole 27b1 by further rotating the nut 33 in the clockwise direction to securely tighten the end of the insertion part 27b while the contact surface 45 is in contact with the corner part 6e of the battery wall 5. Thereby, the battery terminal 20 is assembled to the battery post 7 such that the battery terminal unit 10 is attached to the battery 1.

As illustrated in FIG. 5A, in a case where the first distance and the second distance have respectively the reference values, the contact surface 45 contacts the corner part 6e of the battery wall 5 at the side of the side surface 41b of the cover portion 41 (root side of the rotation stop portion 43) as the battery terminal unit 10 rotates. This avoids the battery wall 5 from entering the moving region MR of the mating connector 50. Thus, the mating connector 50 can be fitted to the connector fitting portion 23b of the connector 23.

As illustrated in FIG. 5B, in a case where the first distance and the second distance respectively have the minimum values within the first dimensional tolerance and the second dimensional tolerance, the contact surface 45 contacts the corner part 6e of the battery wall 5 near the side surface 41b of the cover portion 41 (near the root side of the rotation stop portion 43) as the battery terminal unit 10 rotates. This avoids the battery wall 5 from entering the moving region MR of the mating connector 50. Thus, the mating connector 50 can be fitted to the connector fitting portion 23b of the connector 23.

As illustrated in FIG. 5C, in a case where the first distance and second distance respectively have the maximum values within the first dimensional tolerance and the second dimensional tolerance, the contact surface 45 contacts the corner part 6e of the battery wall 5 at the side of the tip surface 49 (tip side of the rotation stop portion 43) as the battery terminal unit 10 rotates. This avoids the battery wall 5 from entering the moving region MR of the mating connector 50. Thus, the mating connector 50 can be fitted to the connector fitting portion 23b of the connector 23.

Note that in any of the cases illustrated in FIGS. 5A to 5C, even if one of the tip corners of the rotation stop portion 43 is not chamfered, that is, even if the contact surface 45 is not formed, it is possible to avoid the corner part 6e of the battery wall 5 from entering the moving region MR of the mating connector 50. However, in this case, the battery terminal unit 10 stops at a position where the connector fitting portion 23b of the connector 23 is further away from the battery 1, in comparison with the case where the contact surface 45 is formed on the rotation stop portion 43. Therefore, when the mating connector 50 is fitted to the connector fitting portion 23b of the connector 23, there is a possibility that the cable 51 may interfere with a peripheral component 100.

Thus, by forming the contact surface 45 on the rotation stop portion 43 of the battery terminal cover 40, the battery terminal 20 can be stopped in the proper position while absorbing the tolerances in the battery 1.

### (Actions and Effects)

According to the present embodiment, the battery terminal cover 40 includes the cover portion 41 and the rotation stop portion 43. The cover portion 41 can be attached to the battery terminal 20. The rotation stop portion 43 is extended from the cover portion 41, and has the contact surface 45 formed by chamfering.

In a state where the cover portion 41 is attached to the battery terminal 20, when the battery terminal 20 is assembled to the battery post 7 standing on the upper surface 3a of the battery housing 3, the contact surface 45 contacts the corner part 6e of the battery wall 5 provided on the upper surface 3a of the battery housing 3. The contact surface 45 is formed at the position out of the moving region MR of the mating connector 50 with respect to the connector 23 provided on the side of one end of the battery terminal 20. The contact surface 45 contacts the corner part 6e of the battery wall 5 to regulate the rotation of the battery terminal 20 in the direction toward the battery wall 5 with the battery post 7 as the rotation center.

With this configuration, when the battery terminal 20 is assembled to the battery post 7, the rotation of the battery terminal 20 can be stopped near the battery 1 while the battery wall 5 is prevented from entering the moving region MR of the mating connector 50 with respect to the connector 23. Thus, even when the peripheral component 100 is present in a space where the battery 1 is arranged, a worker can mount the mating connector 50 and the cable 51 to the connector 23 such that the mating connector 50 and the cable 51 do not interfere with the battery wall 5 and the peripheral component 100.

According to the present embodiment, the contact surface 45 is formed to absorb a dimensional tolerance between the battery post 7 and the wall surface 6a of the battery wall 5 and a dimensional tolerance between the battery post 7 and the side surface 6d of the battery wall 5. The wall surface 6a and the side surface 6d form the corner part 6e of the battery wall 5.

With this configuration, the tolerance in the battery 1 is absorbed, which allows the worker to certainly mount the mating connector 50 to the connector 23.

Therefore, by using the battery terminal cover 40 with these configurations, it is possible to stop the battery terminal 20 in a proper position while absorbing the tolerance in the battery 1.

According to the present embodiment, the contact surface is formed by one flat surface (the contact surface 45). In the state where the cover portion 41 is attached to the battery terminal 20, the rotation stop portion 43 is located at the side of one end of the battery terminal 20.

With this configuration, it is possible to stop the battery terminal 20 in a proper position while absorbing the tolerance in the battery 1, with a simple configuration.

According to the present embodiment, the battery terminal unit 10 includes the battery terminal 20 to be assembled to the battery post 7 standing on the upper surface 3a of the battery housing 3, and the battery terminal cover 40 described above.

With this configuration, by using the battery terminal unit 10, it is possible to stop the battery terminal 20 in a proper position while absorbing the tolerance in the battery 1.

### Modified Example

In the embodiment described above, the contact surfaces is formed by one flat surface, but the configuration is not limited to this. The contact surface may be formed by two flat surfaces.

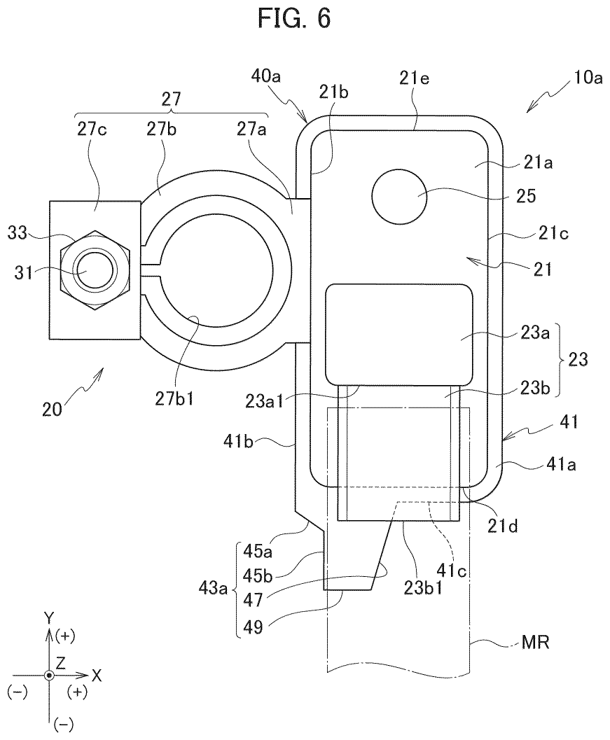

FIG. 6 is a plan view of a battery terminal unit 10a according to the present modified example. As illustrated in FIG. 6, the battery terminal unit 10a includes the battery terminal 20 and a battery terminal cover 40a. The configuration of the battery terminal 20 has been described in the embodiment described above, and is therefore omitted in this modified example.

The battery terminal cover 40a includes the cover portion 41 and a rotation stop portion 43a. The configuration of the cover portion 41 has been described in the embodiment described above, and is therefore omitted in this modified example. The rotation stop portion 43a includes contact surfaces 45a, 45b, the inclined surface 47, and the tip surface 49. The configurations of the inclined surface 47 and the tip surface 49 have been described in the embodiment described above, and are therefore omitted in this modified example.

The contact surfaces 45a, 45b are two flat surfaces formed by chamfering from one of tip corners of the rotation stop portion 43a. In a state where the battery terminal cover 40a is attached to the battery terminal 20, a surface (contact surface) formed by the contact surfaces 45a, 45b is concave toward the battery terminal 20.

The contact surface 45a is connected to the side surface 41b and the contact surface 45b. The contact surface 45b is connected to the tip surface 49. The contact surfaces 45a 45b are formed at the position out of the moving region MR of the mating connector 50 with respect to the connector 23.

In the modified example, the contact surface 45b is formed parallel to the long side direction of the cover portion 41. An angle formed by the contact surfaces 45a, 45b is an obtuse angle. The contact surface 45b is not limited to being formed parallel to the long side direction of the cover portion 41, but may be set appropriately based on a relationship among an installation position of the battery wall 5, an installation position of the battery post 7, and an installation position of one or more peripheral components arranged around the battery 1. Similarly, the angle formed by the contact surfaces 45a, 45b is not limited to be an obtuse angle, but is set as appropriate based on the relationship among the installation position of the battery wall 5, the installation position of the battery post 7, and the installation position of the one or more peripheral components arranged around the battery 1.

The contact surface 45a is also referred to as one flat surface located at a root side of the rotation stop portion 43a. The contact surface 45b is also referred to as the other flat surface located at a tip side of the rotation stop portion 43a.

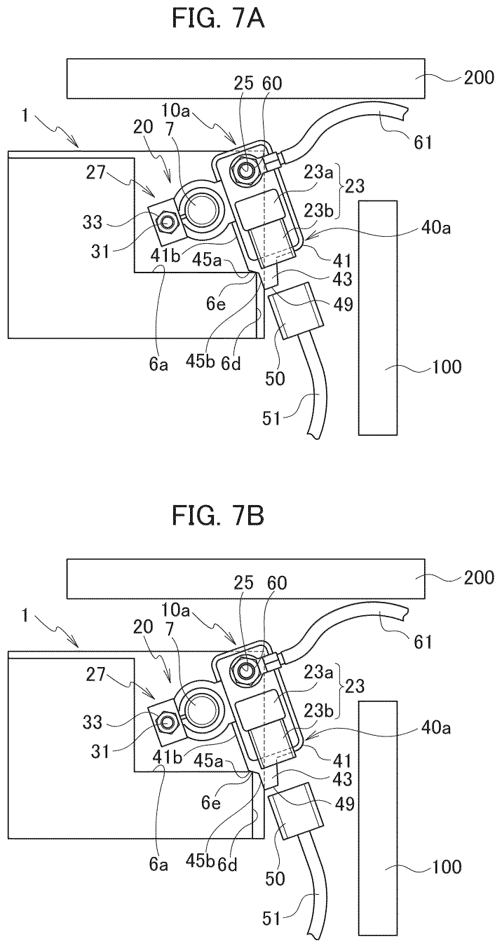

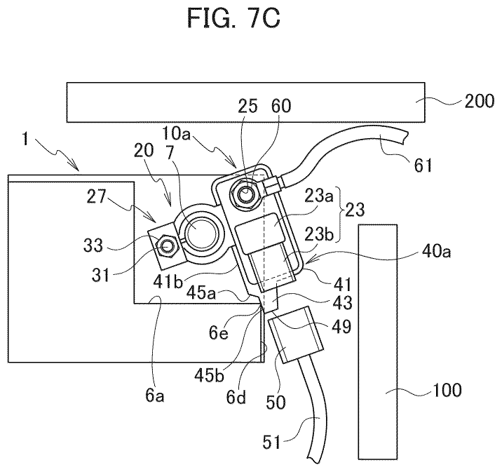

FIG. 7A is an explanatory diagram illustrating absorption of tolerances by the battery terminal cover 40a when the first distance and the second distance respectively have the reference values. FIG. 7B is an explanatory diagram illustrating absorption of the tolerances by the battery terminal cover 40a when the first distance and the second distance respectively have minimum values within the first dimensional tolerance and the second dimensional tolerance. FIG. 7C is an explanatory diagram illustrating absorption of the tolerances by the battery terminal cover 40a when the first distance and the second distance respectively have maximum values within the first dimensional tolerance and the second dimensional tolerance.

As illustrated in FIG. 7A, in a case where the first distance and the second distance respectively have the reference values, the contact surface 45a contacts the corner part 6e of the battery wall 5 near a boundary between the contact surfaces 45a, 45b as the battery terminal unit 10a rotates. This avoids the battery wall 5 from entering the moving region MR of the mating connector 50 with respect to the connector 23. Thus, the mating connector 50 can be fitted to the connector fitting portion 23b of the connector 23.

As illustrated in FIG. 7B, in a case where the first distance and the second distance respectively have the minimum values within the first dimensional tolerance and the second dimensional tolerance, the contact surface 45a contacts the corner part 6e of the battery wall 5 near the side surface 41b of the cover portion 41 as the battery terminal unit 10a rotates. This avoids the battery wall 5 from entering the moving region MR of the mating connector 50 with respect to the connector 23. Thus, the mating connector 50 can be fitted to the connector fitting portion 23b of the connector 23.

As illustrated in FIG. 7C, in a case where the first distance and the second distance respectively have the maximum values within the first dimensional tolerance and the second dimensional tolerance, the contact surface 45b contacts the corner part 6e of the battery wall 5 at the side of the tip surface 49 as the battery terminal unit 10a rotates. This avoids the battery wall 5 from entering the moving region MR of the mating connector 50 with respect to the connector 23. Thus, the mating connector 50 can be fitted to the connector fitting portion 23b of the connector 23.

Note that in any of the cases illustrated in FIGS. 7A to 7C, even if the contact surface is formed by one flat surface, it is possible to avoid the corner part 6e of the battery wall 5 from entering the moving region MR of the mating connector 50 with respect to the connector 23, and avoid the cable 51 of the mating connector 50 from interfering with the peripheral component 100. However, in this case, the battery terminal unit 10a stops at a position where the connector fitting portion 23b of the connector 23 is away from the battery 1, in comparison with the case where the contact surface is formed by two flat surfaces. Therefore, when a mating terminal 60 is connected to the stud bolt 25 of the battery terminal 20, there is a possibility that a cable 61 of the mating terminal 60 may interfere with a peripheral component 200.

Thus, by forming the contact surfaces 45a, 45b on the rotation stop portion 43a of the battery terminal cover 40a, the battery terminal 20 can be stopped in a more proper position while absorbing the tolerances in the battery 1.

Further, when one of tip corners of the rotation stop portion 43a is chamfered to form only the contact surface 45a, a part of the contact surface 45a is formed within the moving region MR of the mating connector 50. Therefore, for example, if the first distance and the second distance respectively have the maximum values within the first dimensional tolerance and the second dimensional tolerance, there is a possibility that the battery wall 5 may enter the moving region MR of the mating connector 50 as the battery terminal unit 10a rotates. However, even in this case, the contact surface 45a is connected to the contact surface 45b at a position outside of the moving region MR of the mating connector 50, which avoid an occurrence that the battery wall 5 enters the moving region MR of the mating connector 50 as the battery terminal unit 10a rotates.

Similarly, when one side of the rotation stop portion 43a is chamfered to form only the contact surface 45b, the contact surface 45b is connected to the side surface 41c of the cover portion 41 exposed on a side of the side surface 41b of the cover portion 41. Therefore, for example, if the first distance has the minimum value within the first dimensional tolerance and the second distance has the maximum value within the second dimensional tolerance, there is a possibility that the battery terminal unit 10a may rotate in the clockwise direction extra toward the battery wall 5, in comparison with the case where the contact surfaces 45a, 45b are formed. In this case, there is a possibility that the cable 51 of the mating connector 50 may interfere with the side surface 3c of the battery housing 3. However, even in this case, the contact surface 45a is connected to the contact surface 45b, which avoids an occurrence that the battery terminal unit 10a rotates in the clockwise direction extra toward the battery wall 5.

According to the present modified example, the contact surface is formed by two flat surfaces (the contact surfaces 45a, 45b). In the state where the cover portion 41 is attached to the battery terminal 20, the rotation stop portion 43a is located at the side of one end of the battery terminal 20, and the surface (contact surface) formed by the contact surfaces 45a, 45b is concave toward the battery terminal 20. A stud bolt 25 is provided on the side of the other end of the battery terminal 20.

With this configuration, when the battery terminal 20 is assembled to the battery post 7, the rotation of the battery terminal 20 can be stopped nearer the battery 1 while the battery wall 5 is prevented from entering the moving region MR of the mating connector 50 with respect to the connector 23. Thus, even when the peripheral components 100, 200 are present in a space where the battery 1 is arranged, a worker can mount the mating connector 50 and the cable 51 to the connector 23 such that the mating connector 50 and the cable 51 do not interfere with the battery wall 5 and the peripheral component 100, and mount the cable 61 of the mating terminal 60 to the connector 23 such that the cable 61 does not interfere with the peripheral component 200.

Therefore, by using the battery terminal cover 40a with this configuration, it is possible to stop the battery terminal 20 in a more proper position while absorbing the tolerance in the battery 1.

According to the present modified example, in a case where the first distance between the battery post 7 and the wall surface 6a of the battery wall 5 has the maximum value within the first dimensional tolerance, and the second distance between the battery post 7 and the side surface 6d of the battery wall 5 has the maximum value within the second dimensional tolerance, the contact surface 45b (one of the contact surfaces 45a, 45b) located at the tip side of the rotation stop portion 43a contacts the corner part 6e. In a case where the first distance between the battery post 7 and the wall surface 6a of the battery wall 5 has the minimum value within the first dimensional tolerance, and the second distance between the battery post 7 and the side surface 6d of the battery wall 5 has the minimum value within the second dimensional tolerance, the contact surface 45a (the other of the contact surfaces 45a, 45b) located at the root side of the rotation stop portion 43a contacts the corner part 6e.

With this configuration, it is possible to certainly absorb the tolerances in the battery 1, with a simple configuration.

### Other Modified Example

In the embodiment described above, the side surface 6d of the battery wall 5 is formed parallel to the side surface 3c of the battery housing 3, but the configuration is not limited to this. For example, the side surface 6d of the battery wall 5 may be formed to be inclined with respect to the upper surface 3a such that as the side surface 6d extends away from the upper surface 3a of the battery housing 3, the side surface 6d extends away from the side surface 3c of the battery housing 3.

In the embodiment described above, the side surface 6d of the battery wall 5 and the side surface 3c of the battery housing 3 do not form one flat surface, but the configuration is not limited to this. The side surface 6d of the battery wall 5 and the side surface 3c of the battery housing 3 may form one flat surface. In this case, the tolerance between the battery post 7 and the side surface 6d of the battery wall 5 matches a tolerance between the battery post 7 and the side surface 3c of the battery housing 3. In this case, the tolerance between the battery post 7 and the side surface 6d of the battery wall 5 can be replaced with the tolerance between the battery post 7 and the side surface 3c of the battery housing 3.

In the embodiment described above, the battery terminal unit 10 contacts the corner part 6e of the battery wall 5 which is formed by the wall surface 6a and the side surface 6d of the battery wall 5, but the configuration is not limited to this. For example, the battery terminal unit 10 may contact a corner part of the battery wall 5 which is formed by the wall surface 6b of the battery wall 5 and a side surface of the battery wall 5 parallel to the front surface 3b of the battery housing 3. In this case, the battery terminal unit 10 rotates in the counterclockwise direction, and contacts the corner part of the battery wall 5 from a side of the front surface 3b of the battery housing 3.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A battery terminal cover comprising:
a cover portion to be attached to a battery terminal; and
a rotation stop portion that is extended from the cover portion, and has a contact surface formed by chamfering, wherein
in a state where the cover portion is attached to the battery terminal, when the battery terminal is assembled to a battery post standing on an upper surface of a battery housing, the contact surface contacts a corner part of a battery wall provided on the upper surface of the battery housing,
the contact surface is formed at a position out of a moving region of a mating connector with respect to a connector provided on a side of one end of the battery terminal,
the contact surface is formed to absorb a dimensional tolerance between the battery post and a first surface of the battery wall and a dimensional tolerance between the battery post and a second surface of the battery wall, the first surface and the second surface forming the corner part, and
the contact surface contacts the corner part to regulate rotation of the battery terminal in a direction toward the battery wall with the battery post as a rotation center.

2. The battery terminal cover according to claim 1, wherein
the contact surface is formed by one flat surface, and
in the state where the cover portion is attached to the battery terminal, the rotation stop portion is located at the side of the one end of the battery terminal.

3. The battery terminal cover according to claim 1, wherein
the contact surface is formed by two flat surfaces,
in a state where the cover portion is attached to the battery terminal, the rotation stop portion is located at the side of the one end of the battery terminal, and the contact surface is concave toward the battery terminal, and
a stud bolt is provided on a side of another end of the battery terminal.

4. The battery terminal cover according to claim 3, wherein
in a case where a first distance between the battery post and the first surface of the battery wall has a maximum value within a first dimensional tolerance, and a second distance between the battery post and the second surface of the battery wall has a maximum value within a second dimensional tolerance, one of the two flat surfaces located at a tip side of the rotation stop portion contacts the corner part, and
in a case where the first distance has a minimum value within the first dimensional tolerance, and the second distance has a minimum value within the second dimensional tolerance, another of the two flat surfaces located at a root side of the rotation stop portion contacts the corner part.

5. A battery terminal unit comprising:
a battery terminal to be assembled to a battery post standing on an upper surface of a battery housing; and
a battery terminal cover, wherein
the battery terminal cover includes:
a cover portion to be attached to the battery terminal; and
a rotation stop portion that is extended from the cover portion, and has a contact surface formed by chamfering,
in a state where the cover portion is attached to the battery terminal, when the battery terminal is assembled to the battery post, the contact surface contacts a corner part of a battery wall provided on the upper surface of the battery housing,
the contact surface is formed at a position out of a moving region of a mating connector with respect to a connector provided on a side of one end of the battery terminal,
the contact surface is formed to absorb a dimensional tolerance between the battery post and a first surface of the battery wall and a dimensional tolerance between the battery post and a second surface of the battery wall, the first surface and the second surface forming the corner part, and
the contact surface contacts the corner part to regulate rotation of the battery terminal in a direction toward the battery wall with the battery post as a rotation center.
